(19) United States
(12) Patent Application Publication
(10) Pub. No.: US 2026/0051942 A1
(43) Pub. Date: Feb. 19, 2026

(54) NEW RADIO-LONG TERM EVOLUTION (NR-LTE) ANTENNA SWAPPING FOR OPTIMAL LINK PERFORMANCE

(71) Applicant: GOOGLE LLC, Mountain View, CA (US)

(72) Inventors: Benjamin WHITE, Mountain View, CA (US); Tivin LIN, Mountain View, CA (US); Matthew SLATER, Mountain View, CA (US); Liyao SHIH, Mountain View, CA (US); Gregory BLACK, Mountain View, CA (US); Robert S. TROCKE, Mountain View, CA (US)

(73) Assignee: GOOGLE LLC, Mountain View, CA (US)

(21) Appl. No.: 19/102,154

(22) PCT Filed: Aug. 9, 2022
(86) PCT No.: PCT/US2022/039876

§ 371 Date: Feb. 7, 2025

(51) Int. Cl. H04B 7/08; H04B 7/06; H04B 17/318

(52) U.S. Cl. CPC H04B 7/0802; H04B 7/0608; H04B 17/328

(57) ABSTRACT

A method, user equipment (UE), and non-transitory computer-readable storage medium for wireless communications are provided. The UE includes a first path including a first radio frequency (RF) transceiver and a first antenna connected to the first RF transceiver, a second path including a second RF transceiver and a second antenna connected to the second RF transceiver, and a processor coupled to the first and second RF transceivers. The method comprising: determining, by the processor, a first signal quality of a first signal received via the first antenna and the first RF transceiver; determining, by the processor, a second signal quality of a second signal received via the second antenna and the second RF transceiver; and selecting, based on a comparison between the first signal quality and the second signal quality, at least one of the first transceiver and the second transceiver for wirelessly communicating RF signals.

### TECHNICAL FIELD

The present disclosure relates to wireless communications, and specifically relates to the fourth generation (4G) and the fifth generation (5G) dual connectivity.

### BACKGROUND

According to the third generation partnership project (3GPP) standards, evolved-universal terrestrial radio access (E-UTRA) new radio (NR) dual connectivity (ENDC) is a non-standalone (NSA) fifth generation (5G) architecture that allows a user equipment (UE) to access both 5G and 4G networks at the same time. One benefit of ENDC is that bandwidths to access the 5G and 4G networks can be combined, effectively allowing carriers to take advantage of the benefits of both network technologies simultaneously.

### SUMMARY

Aspects of the disclosure provide a method of a user equipment (UE) for wireless communication. In the method, a first switch of the UE is switched on to couple a first radio frequency (RF) transceiver of the UE to a baseband processor of the UE through the first switch. The first RF transceiver is associated with a first antenna of the UE. It is determined whether a first signal quality of a first reference signal received by the first antenna is greater than a first threshold. When the first signal quality of the first reference signal is equal to or less than the first threshold, a second switch of the UE is switched on to couple a second RF transceiver of the UE to the baseband processor of the UE through the second switch. The second RF transceiver is associated with a second antenna of the UE. A second signal quality of a second reference signal received by the second antenna is determined. One of the first antenna and the second antenna is selected as a transmit antenna based on a comparison between the first signal quality and the second signal quality.

In an embodiment, when the first signal quality of the first reference signal is greater than the first threshold, the first antenna is selected as the transmit antenna.

In an embodiment, it is determined whether a difference between the second signal quality and the first signal quality is greater than a second threshold. When the difference is greater than the second threshold, the second antenna is selected as the transmit antenna. When the difference is equal to or less than the second threshold, the first antenna is selected as the transmit antenna.

In an embodiment, it is determined whether a flag indicating the first signal quality is to be compared with the second signal quality is enabled. When the flag is disabled, the first antenna is selected as the transmit antenna.

In an embodiment, both the first signal quality and the second signal quality are reference signal received powers (RSRPs).

In an embodiment, the UE supports simultaneous the fourth generation (4G) long term evolution (LTE) and the fifth generation (5G) new radio (NR) transmissions.

In an embodiment, an LTE standalone (SA) mode is enabled before an addition of an NR secondary carrier group (SCG).

Aspects of the disclosure further provide a UE for wireless communication. A switch controller of the UE switches on a first switch of the UE to couple a first RF transceiver of the UE to a baseband processor of the UE through the first switch. The first RF transceiver is associated with a first antenna of the UE. The baseband processor of the UE determines whether a first signal quality of a first reference signal received by the first antenna is greater than a first threshold. When the first signal quality of the first reference signal is equal to or less than the first threshold, the controller of the UE switches on a second switch of the UE to couple a second RF transceiver of the UE to the baseband processor of the UE through the second switch. The second RF transceiver is associated with a second antenna of the UE. The baseband processor of the UE determines a second signal quality of a second reference signal received by the second antenna. The baseband processor of the UE selects one of the first antenna and the second antenna as a transmit antenna based on a comparison between the first signal quality and the second signal quality.

Aspects of the disclosure further provide a non-transitory computer-readable medium storing instructions that, when executed by a computer, cause the computer to perform a method, the method comprising: switching on a first switch of a UE to couple a first RF transceiver of the UE to a baseband processor of the UE through the first switch, the first RF transceiver being associated with a first antenna of the UE, determining whether a first signal quality of a first reference signal received by the first antenna is greater than a first threshold, in response to the first signal quality of the first reference signal being equal to or less than the first threshold, switching on a second switch of the UE to couple a second RF transceiver of the UE to the baseband processor of the UE through the second switch, the second RF transceiver being associated with a second antenna of the UE, determining a second signal quality of a second reference signal received by the second antenna, and selecting one of the first antenna and the second antenna as a transmit antenna based on a comparison between the first signal quality and the second signal quality.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows placements of antennas of a UE (100) according to an embodiment of the disclosure;

FIG. 2 shows placements of antennas of a UE (200) supporting simultaneous 4G LTE and 5G NR transmissions according to an embodiment of the disclosure;

FIG. 3 shows an algorithm of selecting the best performing antenna of a UE such as the UE (200) in FIG. 2 according to an embodiment of the disclosure;

FIG. 4 shows an example of band combinations and antenna mapping according to an embodiment of the disclosure;

FIG. 5 shows an arrangement of circuit blocks of a UE (500) supporting simultaneous 4G LTE and 5G NR transmissions according to an embodiment of the disclosure;

FIG. 6 shows an arrangement of circuit blocks of a UE (600) supporting simultaneous 4G LTE and 5G NR transmissions according to an embodiment of the disclosure;

FIG. 7 shows an arrangement of circuit blocks of a UE (700) supporting simultaneous 4G LTE and 5G NR transmissions according to an embodiment of the disclosure;

FIG. 8 shows an arrangement of circuit blocks of a UE (800) supporting simultaneous 4G LTE and 5G NR transmissions according to an embodiment of the disclosure;

FIG. 9 shows a flowchart outlining a process (900) according to an embodiment of the disclosure;

FIG. 10 shows another flowchart outlining a process (1000) according to an embodiment of the disclosure; and

FIG. 11 shows a UE (1100) according to an embodiment of the disclosure.

### DETAILED DESCRIPTION OF EMBODIMENTS

The fifth-generation (5G) mobile communication utilizes sub 6 GHZ technologies to allow simultaneous operations of multiple transmitters of a user equipment (UE) that supports simultaneous multiple communication connections, such as evolved-universal terrestrial radio access (E-UTRA) new radio (NR) dual connection (ENDC), which is a non-standalone (NSA) feature that allows the UE to connect to both 5G NR and 4G long term evolution (LTE) networks at the same time. In ENDC, the UE may connect to an LTE enodeB (eNB) that acts as a master node and a 5G gnodeB (gNB) that acts as a secondary node. For example, in ENDC, LTE may become a master cell group (MCG) and NR may become a secondary cell group (SCG). The MCG can work as an anchor cell and the UE can perform an initial registration to this anchor cell, and one or more secondary cells can be added to this anchor cell. Thus, the UE supporting ENDC may need multiple antennas including two primary antennas for transmitting LTE and NR carriers, respectively.

For a link budget in the mobile communication, uplink (i.e., UE transmitting) is typically a limiting case, in which a transmitting performance of the UE (e.g., a mobile device) can be optimized as the first priority. However, the UE may have an aggressive industrial design and a large battery that limit a volume of an antenna, so it is challenging to have space for two primary antennas optimized for the transmitting performance of both the LTE and NR carriers.

According to aspects of the disclosure, for a UE having multiple antennas, a subset of the multiple antennas can be selected for simultaneous multiple communication connections. For example, two antennas can be selected as transmit antennas for the LTE and NR operations, respectively. The following embodiments describe a selection of the subset of the multiple antennas of the UE supporting the simultaneous multiple communication connections such as ENDC.

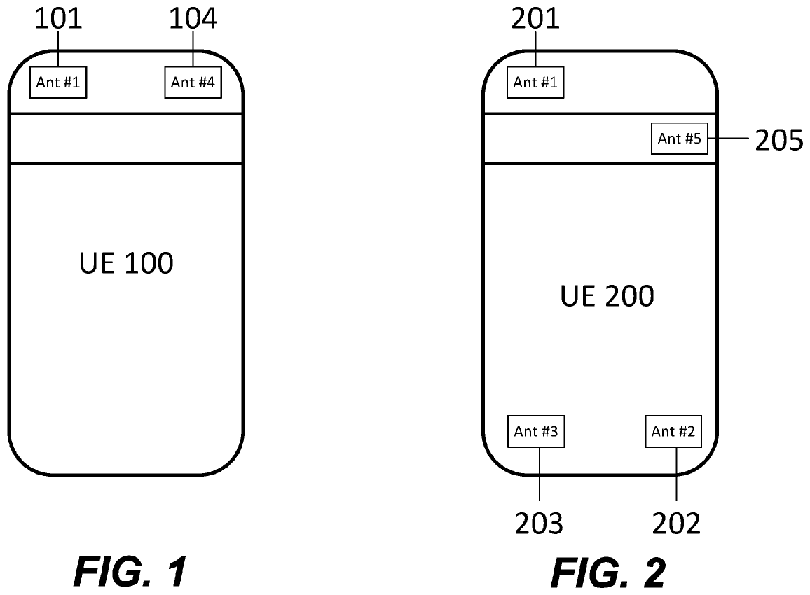

FIG. 1 shows placements of antennas of a UE (100) according to an embodiment of the disclosure.

As shown in FIG. 1, the UE (100) includes two antennas Ant #1 (101) and Ant #4 (104) that are located in an end area of the UE (100) such as a top region of the UE (100) when the UE (100) is held in a portrait orientation with head up. In some embodiments, the antenna Ant #1 (101) can be used for LTE/NR transmission, and the antenna Ant #4 (104) can be used for Global Positioning System (GPS), Wi-Fi, and/or Bluetooth (BT). In an embodiment, the antenna Ant #1 (101) may be the best performing mid band antenna in the top region of the UE (100). However, several factors can challenge the design and the placement of the antenna Ant #1 (101). For example, a continuous metal piece from a bezel to a back of the UE (100) can be used for a camera (not shown in FIG. 1) of the UE (100). This metal piece can push the antenna Ant #1 (101) more towards the top region of the UE (100). A large metal cutout can be removed from the top region of the UE (100) for millimeter wave (mmWave) transmission. All of these factors can push the antenna Ant #1 (101) next to the antenna Ant #4 (104). Since a center of the top region of the UE (100) may be crowded with other components/devices (e.g., a front camera, an earpiece, and an mm Wave module), feed positions of the antennas Ant #1 (101) and #4 (104) are limited to corners of the UE (100), and two high impedance tips of the antennas Ant #1 (101) and #4 (104) are forced next to each other, causing lower performances for the antennas, especially at frequencies around 1.7 GHZ.

FIG. 2 shows placements of antennas of a UE (200) supporting simultaneous 4G LTE and 5G NR transmissions according to an embodiment of the disclosure.

As shown in FIG. 2, the antennas of the UE (200) include two top antennas Ant #1 (201) and Ant #5 (205) which are located at an end area of the UE (200) such as a top region of the UE (200) when the UE (200) is held in a portrait orientation with head up, and two bottom antennas Ant #2 (202) and Ant #3 (203) which are located at the other end area of the UE (200) such as a bottom region of the UE (200) when the UE (200) is held in the portrait orientation with head up. In order to support simultaneous 4G LTE and 5G NR transmissions such as ENDC, the UE (200) can have at least two radio frequency (RF) transceivers or transmitters, in which a first RF transmitter is used for the LTE transmission and a second RF transmitter is used for the NR transmission. In addition, the UE (200) can include other components such as one or more baseband processors, one or more switching circuit blocks, and/or one or more additional antennas.

In some embodiments, transmission (or carrier) performances of the antennas of the UE (200) may be different. In an embodiment, the bottom antennas Ant #2 (202) and Ant #3 (203) may have better over the air (OTA) performances than the top antennas Ant #1 (201) and Ant #5 (205). Thus, the bottom antennas Ant #2 (202) and Ant #3 (203) can be used for standalone (SA) LTE and/or NR transmissions. For the LTE and/or NR SA cases, the UE (200) can select one bottom antenna which has the better OTA performance of the bottom antennas Ant #2 (202) and Ant #3 (203).

In an embodiment, an isolation performance between the bottom antennas Ant #2 (202) and Ant #3 (203) may be poor. Accordingly, for the ENDC cases (e.g., mid band and/or high band ENDC cases), the LTE transmitter and the NR transmitter of the UE (200) should not simultaneously operate with the bottom antennas Ant #2 (202) and Ant #3 (203).

Instead, for the ENDC cases, the bottom antennas Ant #2 (202) and Ant #3 (203) can be used for the LTE transmission, and the top antennas Ant #1 (201) and Ant #5 (205) can be used for the NR transmission. For example, the UE (200) can make a first selection between the bottom antennas Ant #2 (202) and Ant #3 (203) for the LTE transmission, and make a second selection between the top antennas Ant #1 (201) and Ant #5 (205) for the NR transmission.

According to aspects of the disclosure, for the UE (200) having multiple transmit antennas, the carrier performances of all the multiple antennas should be tested and reported. It is noted that carrier requirements for the ENDC cases may not be relaxed compared to carrier requirements for the SA cases. Therefore, the NR transmitter of the UE (200) may need to be tested with the bottom antennas Ant #2 (202) and Ant #3 (203) for the carrier requirements of the ENDC cases.

This disclosure presents processes/methods for selecting a subset of multiple antennas for the LTE and/or NR transmissions. The subset of multiple antennas is selected based on a performance comparison of different transmission modules. Each transmission module may include one of the subset of multiple antenna, an RF transceiver associated with the one of the subset of multiple antenna, and/or a switch associated with the RF transceiver.

Still referring to FIG. 2, it is noted that the RF architecture (e.g., the RF transmitters) of the UE (200) may not allow a switching of an LTE power amplifier (PA) and an NR PA during a connected mode (e.g., a connected call) of the UE (200), so the carrier performances of all the four antennas Ant #1 (201), Ant #2 (202), Ant #3 (203), and Ant #5 (205) can be tested during an LTE SA mode prior to an addition of an NR SCG. Then, the best performing antenna can be determined among the four antennas Ant #1 (201), Ant #2 (202), Ant #3 (203), and Ant #5 (205). If the best performing antenna is one of the bottom antennas Ant #2 (202) and Ant #3 (203), the bottom antennas Ant #2 (202) and Ant #3 (203) can be used for an LTE anchor. If the best performing antenna is one of the top antennas Ant #1 (201) and Ant #5 (205), the top antennas can be used for the LTE anchor.

By testing the four antennas during the LTE SA mode prior to the addition of the NR SCG, the carrier performances of all the four antennas of the UE (200) can be tested and reported. Accordingly, the reporting of the carrier performances of the bottom antennas Ant #2 (202) and Ant #3 (203) for the NR transmission can be enabled, and the NR transmission via the bottom antennas Ant #2 (202) and Ant #3 (203) can be allowed.

It is noted that, in some embodiments, the UE (200) can have one or more additional antennas in addition to the four antennas Ant #1 (201), Ant #2 (202), Ant #3 (203), and Ant #5 (205) shown in FIG. 2. The one or more additional antennas can also be used for the LTE and/or NR transmissions. The carrier performances of the one or more additional antennas can be tested and reported during the LTE SA mode prior to the addition of the NR SCG, and the best performing antenna can be determined based on the carrier performances of all the antennas including the four antennas shown in FIG. 2 and the additional one or more antennas.

According to aspects of the disclosure, the selection of the best performing antenna among multiple antennas can be based on signal qualities of reference signals such as reference signal receive powers (RSRP) received by these antennas. For example, an antenna with the highest RSRP modified by uplink maximum transmit power level (MTPL) differences and transmit/receive (Tx/Rx) antenna imbalance differences can be selected as the best performing antenna.

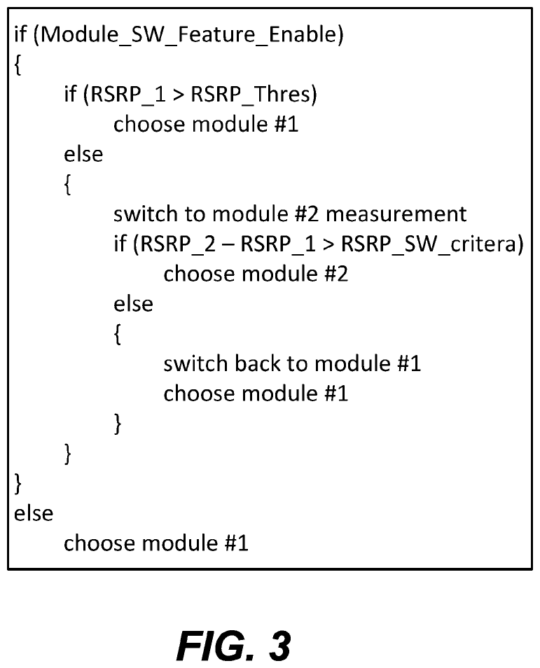

FIG. 3 shows an implementation of an algorithm of selecting the best performing antenna of a UE such as the UE (200) in FIG. 2 according to an embodiment of the disclosure.

In the algorithm shown in FIG. 3, a variable Module_SW_Feature Enable indicates whether the selection of the best performing antenna is enabled. In an example, a type of the variable Module_SW_Feature_Enable can be bool. When the variable Module_SW_Feature_Enable is enabled (e.g., set as 1 or True), the selection is enabled; and when the Module_SW_Feature_Enable is disabled (e.g., set as 0 or False), the selection is disabled.

In the algorithm shown in FIG. 3, the selection can be made based on a comparison of transmission performances (e.g., RSRP) of two transmission modules. Each transmission module includes a respective antenna. For example, the transmission module #1 can include one of the bottom antennas Ant #2 (202) and Ant #3 (203) of the UE (200), and the transmission module #2 can include the other one of the bottom antennas Ant #2 (202) and Ant #3 (203) of the UE (200). In some embodiments, the transmission modules can include other circuit blocks, such as RF transceivers and/or switches.

Variables RSRP_1 and RSRP_2 represent RSRPs received by the two transmission modules (module #1 and module #2), respectively. In an example, the variables RSRP_1 and RSRP_2 represent best (or highest) RSRPs received by the module #1 and module #2, respectively. In an example, types of the variables RSRP_1 and RSRP_2 can be 16-bit integers (e.g., int16).

Variables RSRP Thres and RSRP_SW_critera represent thresholds when comparing the two modules. In an example, a first threshold RSRP_Thres can be set as −95 dBm, and a second threshold RSRP_SW_critera can be set as 3 dB. In an example, a type of the first threshold RSRP Thres can be a 16-bit integer and a type of the second threshold RSRP SW critera can be an 8-bit integer.

In the algorithm shown in FIG. 3, when the variable Module_SW_Feature_Enable indicates the selection is enabled, the RSRP (i.e., RSRP_1) received by the module #1 is compared with the first threshold RSRP Thres. When RSRP_1 is greater than RSRP_Thres, the module #1, which includes the respective antenna such as one of the bottom antennas Ant #2 (202) and Ant #3 (203) of the UE (200), can be selected for performing the NR/LTE transmissions. When RSRP_1 is equal to or less than RSRP_Thres, the RSRP (i.e., RSRP_2) received by the module #2 is measured. Then, a difference between RSRP_2 and RSRP_1 is compared with the second threshold RSRP SW critera. When the difference is greater than RSRP_SW_critera, the module #2, which includes the respective antenna such as the other one of the bottom antennas Ant #2 (202) and Ant #3 (203) of the UE (200), can be selected for performing the NR/LTE transmissions. When the difference is equal to or less than RSRP_SW_critera, the module #1 including the respective antenna can be selected for performing the NR/LTE transmissions. When the variable Module_SW_Feature_Enable indicates the selection is disabled, the module #1 including the respective antenna can be selected for performing the NR/LTE transmissions.

In an embodiment, the algorithm of selecting the best performing antenna can include variables test_mode_enable and fix_module. The variable test_mode_enable can be used for a test purpose and indicates whether a testing module is fixed during the test. In an example, a type of the variable test_mode_enable can be Boolean. When the variable test_mode_enable is enabled (e.g., set as 1 or True), the testing module is fixed during the test; and when the variable test mode_enable is disabled (e.g., set as 0 or False), the testing module is not fixed during the test. When the variable test_mode_enable is enabled, the variable fix_module in valid and indicates which module is fixed during the test. In an example, a type of the variable test mode_enable can be an 8-bit unsigned integer. For example, the variable test_mode_enable is set as 0 to indicate the module #1 in FIG. 3 is fixed during the test and set as 1 to indicate the module #2 in FIG. 3 is fixed during the test.

In an embodiment, the algorithm of selecting the best performing antenna can include a variable Module_SW_Band, which indicates LTE band(s) supporting the algorithm. In an example, a type of the variable Module_SW_Band can be an 8-bit unsigned integer.

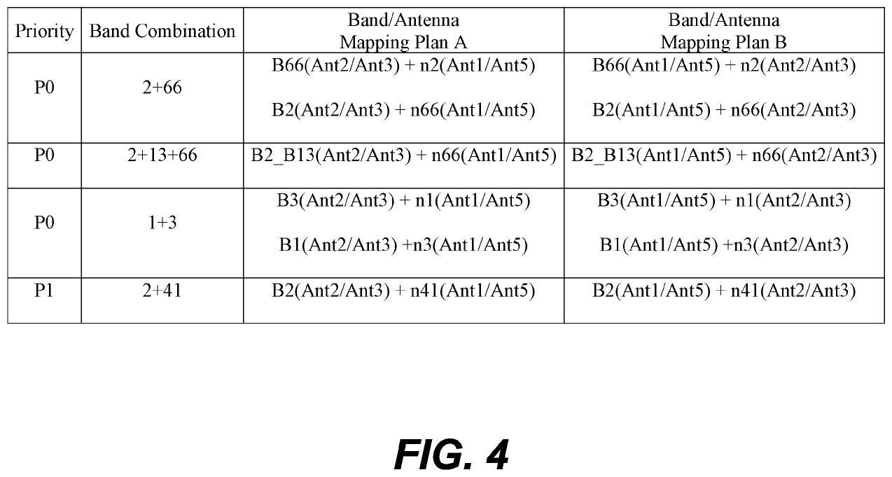

FIG. 4 shows an example of band combinations and antenna mapping according to an embodiment of the disclosure.

As shown in FIG. 4, one or more LTE bands can be combined with an NR band. In an example, an LTE band B2 can be combined with an NR band N66. In another example, two LTE bands B2 and B13 can be combined with the NR band N66. The band/antenna mapping is based on the arrangement of the antennas of the UE (200) in FIG. 2. In the band/antenna mapping plan A, the LTE bands are mapped to the bottom antennas Ant #2 (202) and Ant #3 (203) of the UE (200), and the NR bands are mapped to the top antennas Ant #1 (201) and Ant #5 (205) of the UE (200). In the band/antenna mapping plan B, the LTE bands can be mapped to the top antennas Ant #1 (201) and Ant #5 (205) of the UE (200), and the NR bands can be mapped to the bottom antennas Ant #2 (202) and Ant #3 (203) of the UE (200).

According to aspects of the disclosure, a UE supporting a multi-mode transmission such as simultaneous 4G and 5G transmissions can have multiple RF transceivers with each being associated with one or more antennas. Carrier performances of the multiple antennas of the UE can be tested and compared, and a subset of the multiple antennas (and the associated RF transceivers) can be selected for the multi-mode transmission. The following figures describe some embodiments of the selection of the subset of the multiple antennas (and the associated RF transceivers) of the UE.

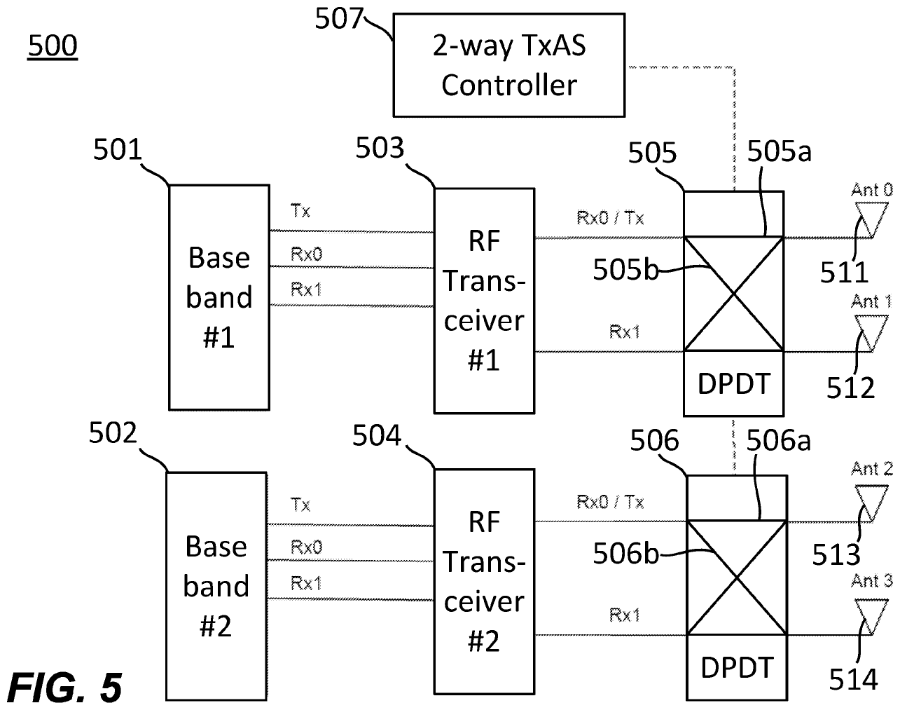

FIG. 5 shows an arrangement of circuit blocks of a UE (500) supporting simultaneous 4G LTE and 5G NR transmissions according to an embodiment of the disclosure.

As shown in FIG. 5, the UE (500) includes two sets of transmission modules (or circuit blocks). A first set of transmission modules includes baseband #1 (501), RF transceiver #1 (503), a first double-pole double-throw (DPDT) switch block (505), and two antennas Ant 0 (511) and Ant 1 (512). The first DPDT switch block (505) is coupled between the RF transceiver #1 (503) and two antennas Ant 0 (511) and Ant 1 (512). A second set of transmission modules includes baseband #2 (502), RF transceiver #2 (504), a second DPDT switch block (506), and two antennas Ant 2 (513) and Ant 3 (514). The second DPDT switch block (506) is coupled between the RF transceiver #2 (504) and two antennas Ant 2 (513) and Ant 3 (514).

It is noted that each baseband circuitry (or circuit block) in FIGS. 5-8, such as the baseband #1 (501) or the baseband #2 (502) in FIG. 5, can be referred to as a baseband processor.

The UE (500) includes a 2-way transmit antenna selection (TxAS) controller (507) which controls the two DPDT switch blocks (505) and (506) to make a selection among the antennas Ant 0 (511)-Ant 3 (514) for the LTE/NR transmissions.

In an example, when the antenna Ant 0 (511) is selected as a transmit antenna, the 2-way TxAS controller (507) can control the first DPDT switch block (505) to turn on a first transmission path (505a) of the first DPDT switch block (505) so that the RF transceiver #1 (503) can transmit a first RF signal to the antenna Ant 0 (511) via the first transmission path (505a) of the first DPDT switch block (505).

In an example, when the antenna Ant 1 (512) is selected as a transmit antenna, the 2-way TxAS controller (507) can control the first DPDT switch block (505) to turn on a second transmission path (505b) of the first DPDT switch block (505) so that the RF transceiver #1 (503) can transmit a second RF signal to the antenna Ant 1 (512) via the second transmission path (505b) of the first DPDT switch block (505).

In an example, when the antenna Ant 2 (513) is selected as a transmit antenna, the 2-way TxAS controller (507) can control the second DPDT switch block (506) to turn on a first transmission path (506a) of the second DPDT switch block (506) so that the RF transceiver #2 (504) can transmit a third RF signal to the antenna Ant 2 (513) via the first transmission path (506a) of the second DPDT switch block (506).

In an example, when the antenna Ant 3 (514) is selected as a transmit antenna, the 2-way TxAS controller (507) can control the second DPDT switch block (506) to turn on a second transmission path (506b) of the second DPDT switch block (506) so that the RF transceiver #2 (504) can transmit a fourth RF signal to the antenna Ant 3 (514) via the second transmission path (506b) of the second DPDT switch block (506).

In some embodiments, the UE (500) can include one or more additional devices and/or components that are not shown in FIG. 5, such as additional baseband processor(s), additional RF transceiver(s), additional antenna(s), one or more memory devices, and the like. In an embodiment, a subset of the one or more additional devices can be coupled between the devices shown in FIG. 5. For example, a power amplifier device (not shown in FIG. 5) can be coupled between the RF transceiver #1 (503) and the first DPDT switch block (505), so that the RF transceiver #1 (503) can transmit an RF signal to the power amplifier device which can amplify the RF signal that is then transmitted via the first DPDT switch block (505) to one of the antennas Ant 0 (511) and Ant 1 (512).

According to aspects of the disclosure, the UE (500) can support simultaneous 4G LTE and 5G NR transmissions such as ENDC. In some embodiments, one of the two sets of transmission modules such as the first set of transmission modules can be used for the LTE transmission, and the other one set of transmission modules such as the second set of transmission modules can be used for the NR transmission. The 2-way TxAS controller (507) can control the first DPDT switch block (505) to select one of the two antennas Ant 0 (511) and Ant 1 (512) for the LTE transmission, and control the second DPDT switch block (506) to select one of the two antennas Ant 2 (513) and Ant 3 (514) for the NR transmission.

In an embodiment, when the first set of transmission modules is selected to be used for the LTE transmission, carrier performances (e.g., RSRP) of the two antennas Ant 0 (511) and Ant 1 (512) can be tested and reported to the baseband #1 (501), and one antenna with a better (or higher) performance (e.g., higher RSRP) can be selected by the baseband #1 (501) for the LTE transmission. In such an embodiment, neither the antenna Ant 0 (511) nor Ant 1 (512) can be used for the NR transmission.

In an embodiment, when the second set of transmission modules is selected to be used for the NR transmission, carrier performances (e.g., RSRP) of the two antennas Ant 2 (513) and Ant 3 (514) can be tested and reported to the baseband #2 (502), and one antenna with a better (or higher) performance (e.g., higher RSRP) can be selected by the baseband #2 (502) for the NR transmission. In such an embodiment, neither the antenna Ant 2 (513) nor Ant 3 (514) can be used for the LTE transmission.

It is noted that the arrangement of circuit blocks of the UE (500) in FIG. 5 limits the usage of the antennas and the RF transceivers. That is, when the baseband #1 (501) is configured for the 4G LTE operation, the associated RF transceiver #1 (503) and the associated antennas Ant 0 (511) and Ant 1 (512) can only be used for the LTE transmission. Similarly, when the baseband #2 (502) is configured for the 5G NR operation, the associated RF transceiver #2 (504) and the associated antennas Ant 2 (513) and Ant 3 (514) can only be used for the NR transmission.

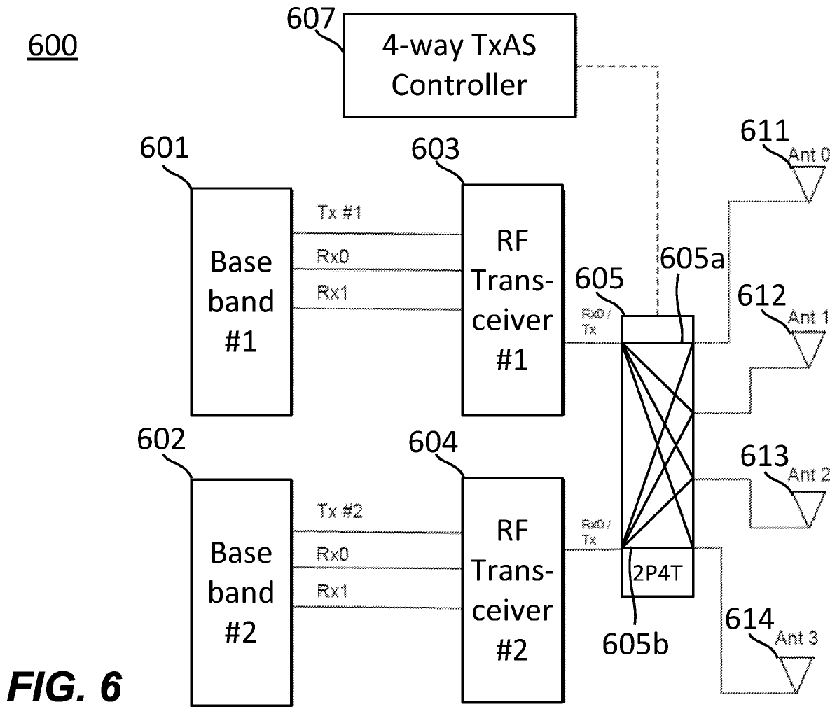

As described above, in an embodiment, an antenna in FIG. 5 is associated with only one of the two RF transceivers without being associated with the other RF transceiver in FIG. 5. Thus, the usage of the antenna is limited by the usage of the associated RF transceiver and cannot be applied to the other RF transceiver. The limitation of the usage of the antennas in FIG. 5 can be relaxed or removed according to an embodiment in FIG. 6. For example, an antenna in FIG. 6 can be associated with each of two RF transceivers in FIG. 6, and thus the usage of the antenna is not limited by the usage of one of the RF transceivers and can be applied to the other RF transceiver.

FIG. 6 shows an arrangement of circuit blocks of a UE (600) supporting simultaneous 4G LTE and 5G NR transmissions according to an embodiment of the disclosure.

As shown in FIG. 6, the UE (600) includes two sets of transmission modules (or circuit blocks). A first set of transmission modules includes baseband #1 (601) and RF transceiver #1 (603). A second set of transmission modules includes baseband #2 (602) and RF transceiver #2 (604). The UE (600) includes four antennas Ant 0 (611), Ant 1 (612), Ant 2 (613), and Ant 3 (614), which are coupled to the two RF transceivers through a two-pole four-throw (2P4T) switch block (605). The UE (600) includes a 4-way TxAS controller (607) which controls the 2P4T switch block (605) to make a selection among the antennas Ant 0 (611)-Ant 3 (614) for the LTE/NR transmissions.

In some embodiments, the UE (600) can include one or more additional devices and/or components that are not shown in FIG. 6, such as additional baseband processor(s), additional RF transceiver(s), additional antenna(s), one or more memory devices, and the like. In an embodiment, a subset of the one or more additional devices can be coupled between the devices shown in FIG. 6. For example, a power amplifier device (not shown in FIG. 6) can be coupled between the RF transceiver #1 (603) and the 2P4T switch block (605), so that the RF transceiver #1 (603) can transmit an RF signal to the power amplifier device which can amplify the RF signal that is then transmitted via the 2P4T switch block (605) to one of the antennas Ant 0 (611)-Ant 3 (614).

According to aspects of the disclosure, the UE (600) can support simultaneous 4G LTE and 5G NR transmissions such as ENDC. In some embodiments, one of the two sets of transmission modules such as the first set of transmission modules can be used for the LTE transmission, and the other one set of transmission modules such as the second set of transmission modules can be used for the NR transmission. The 4-way TxAS controller (607) can control the 2P4T switch block (605) to select one of the four antennas Ant 0 (611)-Ant 3 (614) for the LTE transmission, and to select another one of the four antennas Ant 0 (611)-Ant 3 (614) for the NR transmission.

In an example, when the antenna Ant 0 (611) is selected as a transmit antenna, the 4-way TxAS controller (607) can control the 2P4T switch block (605) to turn on a first transmission path (605a) of the 2P4T switch block (605) so that the RF transceiver #1 (603) can transmit a first RF signal to the antenna Ant 0 (611) via the first transmission path (605a) of the 2P4T switch block (605).

In an example, when the antenna Ant 3 (614) is selected as a transmit antenna, the 4-way TxAS controller (607) can control the 2P4T switch block (605) to turn on a second transmission path (605b) of the 2P4T switch block (605) so that the RF transceiver #2 (604) can transmit a second RF signal to the antenna Ant 3 (614) via the second transmission path (605b) of the 2P4T switch block (605).

It is noted that similar methods can be applied to select another antenna as a transmit antenna.

In an embodiment, carrier performances (e.g., RSRP) of the four antennas Ant 0 (611)-Ant 3 (614) can be tested and reported, and two antennas with better (or higher) performance (e.g., higher RSRP) than the other two antennas can be selected for the LTE and NR transmissions, respectively. For example, if the antennas Ant 0 (611) and Ant 3 (614) are selected for the LTE and NR transmissions, respectively, the 4-way TxAS controller (607) can control the 2P4T switch block (605) to turn on the first transmission path (605a) and the second transmission path (605b), respectively. Accordingly, the RF transceivers #1 (603) and #2 (604) can transmit a first RF signal and a second RF signal to the antennas Ant 0 (611) and Ant 3 (614) via the first transmission path (605a) and the second transmission path (605b) of the 2P4T switch block (605), respectively. The first RF signal and the second RF signal are based on a first baseband signal transmitted from the baseband #1 (601) and a second baseband signal transmitted from the baseband (602), respectively.

It is noted that the arrangement of circuit blocks of the UE (600) in FIG. 6 limits the usage of the RF transceivers. That is, when the baseband #1 (601) is configured for the 4G LTE operation, the associated RF transceiver #1 (603) can only be used for the LTE transmission. Similarly, when the baseband #2 (602) is configured for the 5G NR operation, the associated RF transceiver #2 (604) can only be used for the NR transmission.

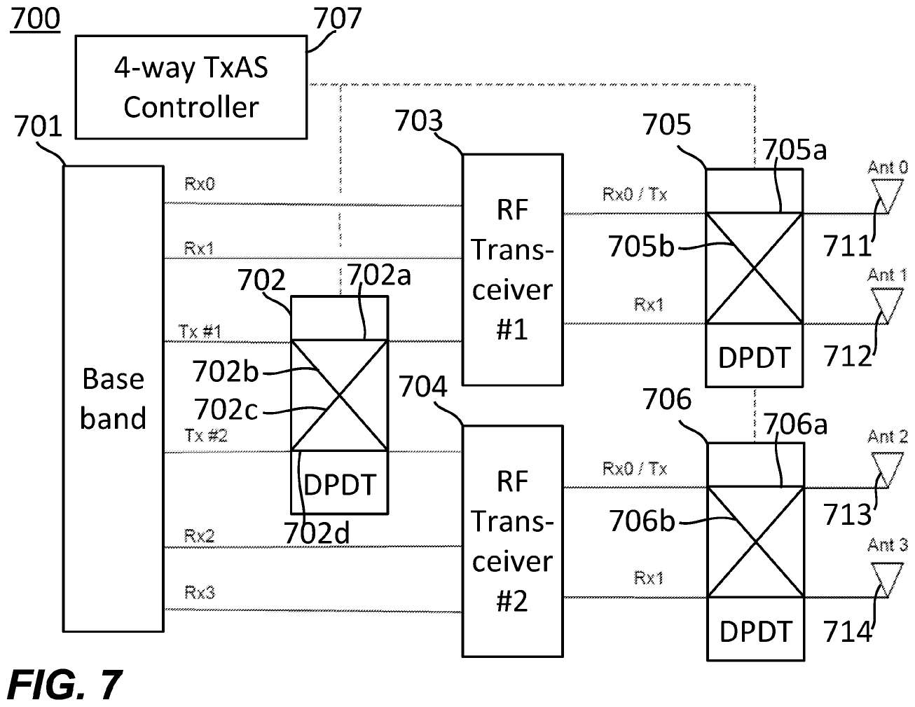

As described above, in an embodiment, each of the RF transceivers in FIG. 6 is associated with only one of the two baseband processors, without being associated with the other baseband processor in FIG. 6. Thus, the usage of the RF transceiver is limited by the usage of the associated baseband processor and cannot be applied to the other baseband processor. The limitation of the usage of the RF transceivers in FIG. 6 can be relaxed or removed according to an embodiment in FIG. 7. For example, both RF transceivers in FIG. 7 are associated with one baseband processor, and thus the usage of each RF transceiver is not limited by the usage of the baseband processor and can be applied to either the LTE or NR transmission.

FIG. 7 shows an arrangement of circuit blocks of a UE (700) supporting simultaneous 4G LTE and 5G NR transmissions according to an embodiment of the disclosure.

As shown in FIG. 7, the UE (700) includes two sets of transmission modules (or circuit blocks). A first set of transmission modules includes RF transceiver #1 (703), a first DPDT switch block (705), and two antennas Ant 0 (711) and Ant 1 (712). The first DPDT switch block (705) is coupled between the RF transceiver #1 (703) and two antennas Ant 0 (711) and Ant 1 (712). A second set of transmission modules includes RF transceiver #2 (704), a second DPDT switch block (706), and two antennas Ant 2 (713) and Ant 3 (714). The second DPDT switch block (706) is coupled between the RF transceiver #2 (704) and two antennas Ant 2 (713) and Ant 3 (714).

The UE (700) includes a baseband processor (701) that is coupled to the two RF transceivers #1 (703) and #2 (704) through a third DPDT switch block (702).

In an embodiment, the third DPDT switch block (702) is directly connected to the baseband processor (701) and the two RF transceivers #1 (703) and #2 (704), such that no other component is located therebetween.

In an embodiment, the third DPDT switch block (702) is directly connected to the two RF transceivers #1 (703) and #2 (704), but one or more first components can be located between the baseband processor (701) and the third DPDT switch block (702).

In an embodiment, the third DPDT switch block (702) is directly connected to the baseband processor (701), but one or more second components can be located between the third DPDT switch block (702) and at least one of the RF transceivers #1 (703) and #2 (704).

In an embodiment, the one or more first components can be located between the baseband processor (701) and the third DPDT switch block (702), and the one or more second components can be located between the third DPDT switch block (702) and at least one of the RF transceivers #1 (703) and #2 (704).

The UE (700) includes a 4-way transmit antenna selection (TxAS) controller (707) which controls the three DPDT switch blocks (702), (705), and (706).

The 4-way TxAS controller (707) can control the first DPDT switch block (705) to make a selection between the antennas Ant 0 (711) and Ant 1 (712) for the LTE/NR transmissions.

In an example, when the antenna Ant 0 (711) is selected as a transmit antenna, the 4-way TxAS controller (707) can control the first DPDT switch block (705) to turn on a first transmission path (705a) of the first DPDT switch block (705) so that the RF transceiver #1 (703) can transmit a first RF signal to the antenna Ant 0 (711) via the first transmission path (705a) of the first DPDT switch block (705).

In an example, when the antenna Ant 1 (712) is selected as a transmit antenna, the 4-way TxAS controller (707) can control the first DPDT switch block (705) to turn on a second transmission path (705b) of the first DPDT switch block (705) so that the RF transceiver #1 (703) can transmit a second RF signal to the antenna Ant 1 (712) via the second transmission path (705b) of the first DPDT switch block (705).

The 4-way TxAS controller (707) can control the second DPDT switch block (706) to make a selection between the antennas Ant 2 (713) and Ant 3 (714) for the LTE/NR transmissions.

In an example, when the antenna Ant 2 (713) is selected as a transmit antenna, the 4-way TxAS controller (707) can control the second DPDT switch block (706) to turn on a first transmission path (706a) of the second DPDT switch block (706) so that the RF transceiver #2 (704) can transmit a third RF signal to the antenna Ant 2 (713) via the first transmission path (706a) of the second DPDT switch block (706).

In an example, when the antenna Ant 3 (714) is selected as a transmit antenna, the 4-way TxAS controller (707) can control the second DPDT switch block (706) to turn on a second transmission path (706b) of the second DPDT switch block (706) so that the RF transceiver #2 (704) can transmit a fourth RF signal to the antenna Ant 3 (714) via the second transmission path (706b) of the second DPDT switch block (706).

The 4-way TxAS controller (707) can control the third DPDT switch block (702) to make a selection between the RF transceivers #1 (703) and #2 (704) for the LTE/NR transmissions.

In an example, when the RF transceiver #1 (703) is selected for one of the LTE and NR transmissions, for example the LTE transmission, the 4-way TxAS controller (707) can control the third DPDT switch block (702) to turn on a first transmission path (702a) of the third DPDT switch block (702) so that the baseband processor (701) can transmit a first baseband signal to the RF transceiver #1 (703) via the first transmission path (702a) of the third DPDT switch block (702).

In an example, when the RF transceiver #2 (704) is selected for the one of the LTE and NR transmissions, for example the LTE transmission, the 4-way TxAS controller (707) can control the third DPDT switch block (702) to turn on a second transmission path (702b) of the third DPDT switch block (702) so that the baseband processor (701) can transmit a second baseband signal to the RF transceiver #2 (704) via the second transmission path (702b) of the third DPDT switch block (702).

In an example, when the RF transceiver #1 (703) is selected for the other one of the LTE and NR transmissions, for example the NR transmission, the 4-way TxAS controller (707) can control the third DPDT switch block (702) to turn on a third transmission path (702c) of the third DPDT switch block (702) so that the baseband processor (701) can transmit a third baseband signal to the RF transceiver #1 (703) via the third transmission path (702c) of the third DPDT switch block (702).

In an example, when the RF transceiver #2 (704) is selected for the other one of the LTE and NR transmissions, for example the NR transmission, the 4-way TxAS controller (707) can control the third DPDT switch block (702) to turn on a fourth transmission path (702d) of the third DPDT switch block (702) so that the baseband processor (701) can transmit a fourth baseband signal to the RF transceiver #2 (704) via the fourth transmission path (702d) of the third DPDT switch block (702).

In some embodiments, the UE (700) can include one or more additional devices and/or components that are not shown in FIG. 7, such as additional baseband processor(s), additional RF transceiver(s), additional antenna(s), one or more memory devices, and the like. In an embodiment, a subset of the one or more additional devices can be coupled between the devices shown in FIG. 7. For example, a power amplifier device (not shown in FIG. 7) can be coupled between the RF transceiver #1 (703) and the first DPDT switch block (705), so that the RF transceiver #1 (703) can transmit an RF signal to the power amplifier device which can amplify the RF signal that is then transmitted via the first DPDT switch block (705) to one of the antennas Ant 0 (711) and Ant 1 (712).

According to aspects of the disclosure, the UE (700) can support simultaneous 4G LTE and 5G NR transmissions such as ENDC. In some embodiments, the 4-way TxAS controller (707) can control the third DPDT switch block (702) to select one of the two sets of transmission modules such as the first set of transmission modules for the LTE transmission, and to select the other one set of transmission modules such as the second set of transmission modules for the NR transmission.

In an embodiment, the UE (700) can test and compare carrier performances (e.g., RSRP) of all the four antennas Ant 0 (711)-Ant 3 (713), and then select the antenna with the best (or highest) performance (e.g., highest RSRP) for the LTE/NR transmission. For example, when the carrier performance of the antenna Ant 0 (711) is to be tested, the 4-way TxAS controller (707) can control the third DPDT switch block (702) and the first DPDT switch block (705) to turn on a transmission path between the baseband processor (701) and the antenna Ant 0 (711). Specifically, the 4-way TxAS controller (707) can control the third DPDT switch block (702) to turn on a transmission path of the third DPDT switch block (702) between the baseband processor (701) and the RF transceiver #1 (703), such as the first transmission path (702a) of the third DPDT switch block (702). Accordingly, the baseband processor (701) can transmit a baseband signal to the RF transceiver #1 (703) via the first transmission path (702a) of the third DPDT switch block (702). In addition, the 4-way TxAS controller (707) can control the first DPDT switch block (705) to turn on a transmission path of the first DPDT switch block (705) between the RF transceiver #1 (703) and the antenna Ant 0 (711), such as the first transmission path (705a) of the first DPDT switch block (705). Accordingly, the RF transceiver #1 (703) can transmit an RF signal to the antenna Ant 0 (711) via the first transmission path (705a) of the first DPDT switch block (705). The RF signal is generated based on the baseband signal transmitted from the baseband (701). When the other three antennas are to be tested, similar methods can be applied to turn on transmission paths each between the baseband processor (701) and a respective antenna.

It is noted that the arrangement of circuit blocks of the UE (700) can support up to two simultaneous transmissions. However, in some embodiments, more than two simultaneous transmissions may be needed.

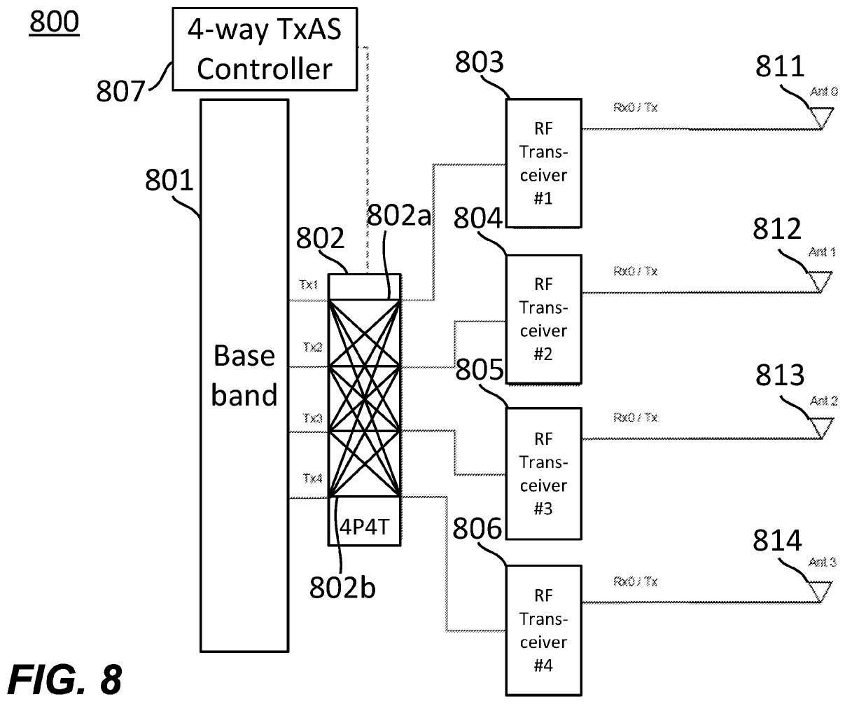

FIG. 8 shows an arrangement of circuit blocks of a UE (800) supporting four simultaneous transmissions according to an embodiment of the disclosure.

As shown in FIG. 8, the UE (800) includes four RF transceivers #1 (803), #2 (804), #3 (805), and #4 (806) each corresponding to a respective antenna of four antennas Ant 0 (811), Ant 1 (812), Ant 2 (813), and Ant 3 (814).

The UE (800) includes a baseband processor (801) which is coupled to the four RF transceivers #1 (803)-#4 (806) through a four-pole four-throw (4P4T) switch block (802).

In an embodiment, the 4P4T switch block (802) is directly connected to the baseband processor (801) and the four RF transceivers #1 (803)-#4 (806), such that no other component is located therebetween.

In an embodiment, the 4P4T switch block (802) is directly connected to the four RF transceivers #1 (803)-#4 (806), but one or more first components can be located between the baseband processor (801) and the 4P4T switch block (802).

In an embodiment, the 4P4T switch block (802) is directly connected to the baseband processor (801), but one or more second components can be located between the 4P4T switch block (802) and at least one of the RF transceivers #1 (803)-#4 (806).

In an embodiment, the one or more first components can be located between the baseband processor (801) and the 4P4T switch block (802), and the one or more second components can be located between the 4P4T switch block (802) and at least one of the RF transceivers #1 (803)-#4 (806).

The UE (800) includes a 4-way TxAS controller (807) that controls the 4P4T switch block (802) to make a selection among the RF transceivers #1 (803)-#2 (806) for the LTE/NR transmissions.

In an example, when the RF transceiver #1 (803) is selected to receive and modulate a first baseband signal transmitted via a port Tx1 of the baseband processor (801), the 4-way TxAS controller (807) can control the 4P4T switch block (802) to turn on a first transmission path (802a) of the 4P4T switch block (802) so that the baseband processor (801) can transmit the first baseband signal to the RF transceiver #1 (803) via the first transmission path (802a) of the 4P4T switch block (802). Then, the RF transceiver #1 (803) can transmit a first RF signal to the antenna Ant 0 (811). The first RF signal is generated based on the first baseband signal.

In an example, when the RF transceiver #4 (806) is selected to receive and modulate a second baseband signal transmitted via a port Tx4 of the baseband processor (801), the 4-way TxAS controller (807) can control the 4P4T switch block (802) to turn on a second transmission path (802b) of the 4P4T switch block (802) so that the baseband processor (801) can transmit the second baseband signal to the RF transceiver #4 (806) via the second transmission path (802b) of the 4P4T switch block (802). Then, the RF transceiver #4 (806) can transmit a second RF signal to the antenna Ant 3 (814). The second RF signal is generated based on the second baseband signal.

It is noted that similar methods can be applied to select other RF transceivers for the LTE/NR transmissions.

In some embodiments, the UE (800) can include one or more additional devices and/or components that are not shown in FIG. 8, such as additional baseband processor(s), additional RF transceiver(s), additional antenna(s), one or more memory devices, and the like. In an embodiment, a subset of the one or more additional devices can be coupled between the devices shown in FIG. 8. For example, a power amplifier device (not shown in FIG. 8) can be coupled between the RF transceiver #1 (803) and the antenna Ant 0 (811), so that the RF transceiver #1 (803) can transmit an RF signal to the power amplifier device which can amplify the RF signal that is then transmitted via the antenna Ant 0 (811).

According to aspects of the disclosure, the UE (800) can support simultaneous 4G LTE and 5G NR transmissions such as ENDC. In some embodiments, the 4-way TxAS controller (807) can control the 4P4T switch block (802) to select one of the four RF transceivers such as the RF transceiver #1 (803) for the LTE transmission, and to select another one of the four RF transceivers such as the RF transceiver #2 (804) for the NR transmission.

In an embodiment, the UE (800) can test and compare carrier performances (e.g., RSRP) of all the four antennas Ant 0 (811)-Ant 3 (813), and then select the antenna with the best (or highest) performance (e.g., highest RSRP) for the LTE/NR transmission. For example, when the carrier performance of the antenna Ant 0 (811) is to be tested, the 4-way TxAS controller (807) can control the 4P4T switch block (802) to turn on a transmission path between the baseband processor (801) and the antenna Ant 0 (811). Specifically, the 4-way TxAS controller (807) can control the 4P4T switch block (802) to turn on a transmission path between the baseband processor (801) and the RF transceiver #1 (803), such as the first transmission path (802a) of the 4P4T switch block (802). Accordingly, the baseband processor (801) can transmit a baseband signal to the RF transceiver #1 (803) via the first transmission path (802a) of the 4P4T switch block (802). Then, the RF transceiver #1 (803) can transmit an RF signal based on the baseband signal to the antenna Ant 0 (811). When the other three antennas are to be tested, similar methods can be applied to turn on transmission paths each between the baseband processor (801) and a respective antenna.

The embodiments described above can be implemented using flowcharts.

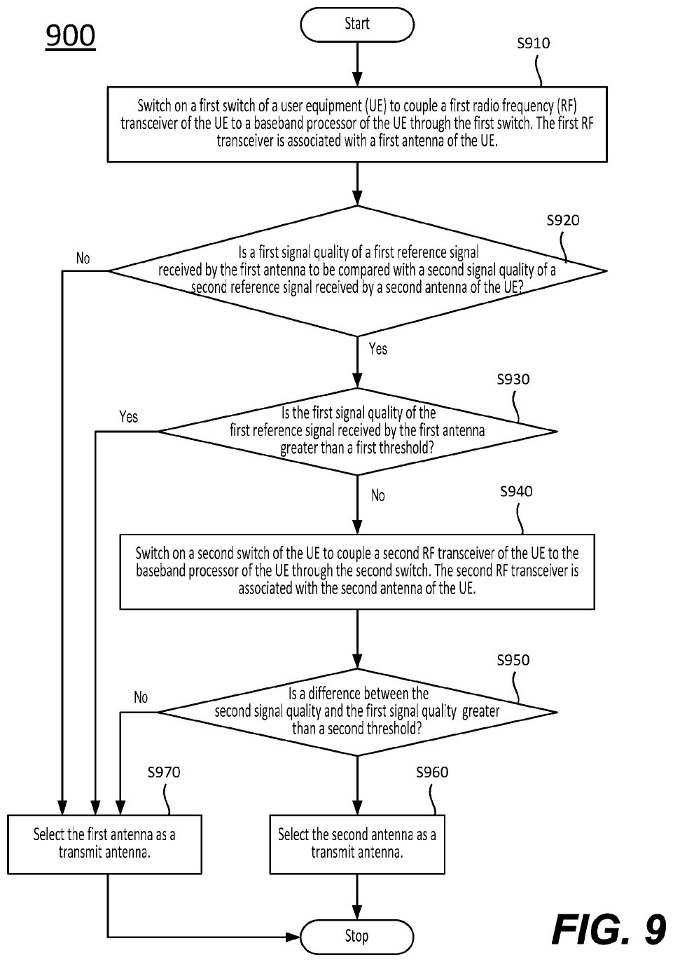

FIG. 9 shows a flowchart outlining a process (900) according to an embodiment of the disclosure. The process (900) can be executed by processing circuitry of an apparatus for wireless communications. The processing circuitry of the apparatus can include a baseband processor (e.g., one of the baseband processors in FIGS. 5-8) and a switch controller (e.g., one of the switch controllers in FIGS. 5-8). The apparatus can be a UE such as the UE (700) or (800). The process (900) can be implemented in software instructions, and, when the processing circuitry executes the software instructions, the processing circuitry performs the process (900).

The process (900) may generally start at step (S910), where the process (900) switches on a first switch of a UE to couple a first RF transceiver of the UE to a baseband processor of the UE through the first switch. The first RF transceiver is associated with a first antenna of the UE. Then, the process (900) proceeds to step (S920).

In an embodiment, when the UE is the UE (700), the baseband processor is the baseband processor (701), and the first switch can be one of the transmission paths of the third DPDT switch block (702), such as the first transmission path (702a). Accordingly, the first RF transceiver can be the RF transceiver #1 (703), and the first antenna can be one of the antennas Ant 0 (711) and Ant 1 (712).

In an embodiment, when the UE is the UE (800), the baseband processor is the baseband processor (801), and the first switch can be one of the transmission paths of the 4P4T switch block (802), such as the first transmission path (802a). Accordingly, the first RF transceiver can be the RF transceiver #1 (803), and the first antenna can be the antenna Ant 0 (811).

At step (S920), the process (900) determines whether a first signal quality of a first reference signal received by the first antenna of the UE is to be compared with a second signal quality of a second reference signal received by a second antenna of the UE based on a flag signal indicating whether a performance comparison of multiple antennas is enabled. If the flag signal indicates that the performance comparison of multiple antennas is enabled, the process (900) determines that the first signal quality is to be compared with the second signal quality, and proceeds to step (S930). Otherwise, the process (900) proceeds to step (S970). In an embodiment, the flag signal can be the variable Module_SW_Feature_Enable in the algorithm of FIG. 3.

At step (S930), the process (900) determines whether the first signal quality of the first reference signal received by the first antenna of the UE is greater than a first threshold. If the process (900) determines that the first signal quality is greater than the first threshold, the process (900) proceeds to step (S970). Otherwise, the process (900) proceeds to step (S940). At step (S940), the process (900) switches on a second switch of the UE to couple a second RF transceiver of the UE to the baseband processor of the UE through the second switch. The second RF transceiver is associated with the second antenna of the UE.

Then, the process (900) proceeds to step (S950).

In an embodiment, when the UE is the UE (700), the second switch can be one of the transmission paths of the third DPDT switch block (702), such as the second transmission path (702b). Accordingly, the second RF transceiver can be the RF transceiver #2 (704), and the second antenna can be one of the antennas Ant 2 (713) and Ant 3 (714).

In an embodiment, when the UE is the UE (800), the second switch can be one of the transmission paths of the 4P4T switch block (802), such as the second transmission path (802b). Accordingly, the second RF transceiver can be the RF transceiver #4 (806), and the second antenna can be the antenna Ant 3 (814).

At step (S950), the process (900) determines whether a difference between the second signal quality and the first signal quality is greater than a second threshold. If the process (900) determines that the difference is greater than the second threshold, the process (900) proceeds to step (S960). Otherwise, the process (900) proceeds to step (S970).

At step (S960), the process (900) selects the second antenna as a transmit antenna to perform an RF transmission. The RF transmission is performed through the second RF transceiver associated with the second antenna, and through the second switch coupled to the second RF transceiver.

At step (S970), the process (900) selects the first antenna as the transmit antenna to perform the RF transmission. The RF transmission is performed through the first RF transceiver associated with the first antenna, and through the first switch coupled to the first RF transceiver.

Then, the process (900) terminates.

In some embodiments, the UE in the process (900) can be one of the UEs as discussed above with reference to FIGS. 1-8.

In an embodiment, both the first switch and the second switch can be implemented in a same switch block such as the third DPDT switch block (702) when the UE is the UE (700) or the 4P4T switch block (802) when the UE is the UE (800).

In an embodiment, both the first and second signal qualities can be RSRPs. In an embodiment, the first threshold can be a value (e.g., −95 dBm) of the variable RSRP Thres in the algorithm shown in FIG. 3, and the second can be a value (e.g., 3 dB) of the variable RSRP SW_critera in the algorithm shown in FIG. 3.

In an embodiment, the UE in process (900) can support simultaneous 4G LTE and 5G NR transmissions such as ENDC.

In an embodiment, the UE can enable an LTE SA mode before an addition of an NR SCG.

It is noted that the UE in the process (900) can have one or multiple RF transceivers. When the UE has only one RF transceiver, the performance comparison of different antennas (and the associated RF transceivers) may not be needed. Thus, the flag indicates that the performance comparison of multiple antennas is disabled, and the process (900) determines that the first signal quality is not to be compared with the second signal quality, and selects the first antenna as the transmit antenna to perform the RF transmission.

As can be seen, the flowchart in FIG. 9 shows multiple scenarios and corresponding solutions, and a transition from step (S920) to step (S970) can be applied to a UE having only one RF transceiver.

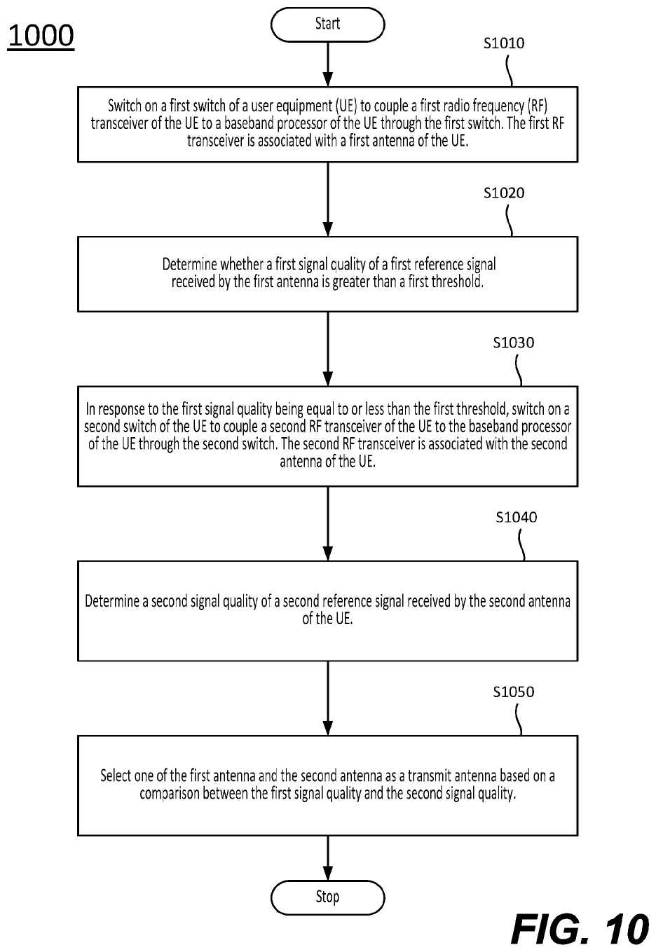

FIG. 10 shows another flowchart outlining a process (1000) according to an embodiment of the disclosure. The process (1000) is applied to a UE having at least two RF transceivers and each of the at least two RF transceivers is associated with at least one different antenna. The process (1000) can be a part of the process (900) in which the flag indicates that the performance comparison of multiple antennas is enabled. Specifically, steps (S1010), (S1020), and (S1030) in FIG. 10 can be equivalent to steps (S910), (S930), and (S940) in FIG. 9, respectively, and step (S1040) can be a combination of steps (S950), (S960), and (S970). Due to being applied to the UE having at least two RF transceivers, the process (1000) does not include the transition from step (S920) to step (S970) in FIG. 9.

The process (1000) can be executed by processing circuitry of an apparatus for wireless communications. The processing circuitry of the apparatus can include a baseband processor (e.g., one of the baseband processors in FIGS. 5-8) and a switch controller (e.g., one of the switch controllers in FIGS. 5-8). The apparatus can be a UE such as the UE (700) or (800). The process (1000) can be implemented in software instructions, and, when the processing circuitry executes the software instructions, the processing circuitry performs the process (1000).

The process (1000) may generally start at step (S1010), where the process (1000) switches on a first switch of a UE to couple a RF transceiver of the UE to a baseband processor of the UE through the first switch. The first RF transceiver is associated with a first antenna of the UE. Then, the process (1000) proceeds to step (S1020).

In an embodiment, when the UE is the UE (700), the baseband processor is the baseband processor (701), and the first switch can be one of the transmission paths of the third DPDT switch block (702), such as the first transmission path (702a). Accordingly, the first RF transceiver can be the RF transceiver #1 (703), and the first antenna can be one of the antennas Ant 0 (711) and Ant 1 (712).

In an embodiment, when the UE is the UE (800), the baseband processor is the baseband processor (801), and the first switch can be one of the transmission paths of the 4P4T switch block (802), such as the first transmission path (802a). Accordingly, the first RF transceiver can be the RF transceiver #1 (803), and the first antenna can be the antenna Ant 0 (811).

At step (S1020), the process (1000) determines whether a first signal quality of a first reference signal received by the first antenna is greater than a first threshold. When the first signal quality is equal to or less than the first threshold, the process (1000) proceeds to step (S1030).

In an embodiment, the first threshold can be a value (e.g., −95 dBm) of the variable RSRP Thres in the algorithm of FIG. 3.

At step (S1030), the process (1000) switches on a second switch of the UE to couple a second RF transceiver of the UE to the baseband processor of the UE through the second switch. The second RF transceiver is associated with the second antenna of the UE.

Then, the process (1000) proceeds to step (S1040).

In an embodiment, when the UE is the UE (700), the second switch can be one of the transmission paths of the third DPDT switch block (702), such as the second transmission path (702b). Accordingly, the second RF transceiver can be the RF transceiver #2 (704), and the second antenna can be one of the antennas Ant 2 (713) and Ant 3 (714).

In an embodiment, when the UE is the UE (800), the second switch can be one of the transmission paths of the 4P4T switch block (802), such as the second transmission path (802b). Accordingly, the second RF transceiver can be the RF transceiver #4 (806), and the second antenna can be the antenna Ant 3 (814).

At step (S1040), the process (1000) determines a second signal quality of a second reference signal received by the second antenna of the UE. Then, the process (1000) proceeds to step (S1050).

At step (S1050), the process (1000) selects one of the first antenna and the second antenna as a transmit antenna based on a comparison between the first signal quality and the second signal quality.

Then, the process (1000) terminates.

In some embodiments, the UE in the process (1000) can be one of the UEs as discussed above with reference to FIGS. 1-8.

In an embodiment, both the first switch and the second switch can be implemented in a same switch block such as the third DPDT switch block (702) when the UE is the UE (700) or the 4P4T switch block (802) when the UE is the UE (800).

In an embodiment, the process (1000) determines whether a flag indicating the first signal quality is to be compared with the second signal quality is enabled. When the flag is enabled, the process (1000) compares the first signal quality with the second signal quality and selects one of the first antenna and the second antenna as the transmit antenna based on the comparison. When the flag is disabled, the process (1000) selects the first antenna as the transmit antenna.

In an embodiment, the flag can be the variable Module_SW_Feature_Enable in the algorithm of FIG. 3.

In an embodiment, whether the flag is enabled or disabled is preconfigured (or predefined), for example, in the algorithm of FIG. 3. The pre-configuration can depend on a comparison of the RSRP from the antenna employed as the transmitting antenna with a threshold. If the RSRP from the antenna employed as the transmitting antenna does not exceed the threshold, then it is likely that selecting a different antenna for transmission can result in improved radio uplink performance. Thus, if the RSRP does not exceed the threshold, the process of measuring RSRP on other antennas can be enabled in order to determine whether the radio uplink performance can be improved. If the RSRP exceeds the threshold, then it is unlikely that selecting a different antenna for transmission can result in improved radio link performance, and the process of measuring RSRP on other antennas can be suspended. Advantageously the operation in this embodiment can save power and/or allow computational resources to be used for other processes.

In an embodiment, when the first signal quality is greater than the first threshold, the process (1000) selects the first antenna as the transmit antenna.

In an embodiment, the process (1000) determines whether a difference between the second signal quality and the first signal quality is greater than a second threshold. When the difference is greater than the second threshold, the process (1000) selects the second antenna as the transmit antenna. Otherwise, the process (1000) selects the first antenna as the transmit antenna.

In an embodiment, the second threshold can be a value (e.g., 3 dB) of the variable RSRP SW_critera in the algorithm shown in FIG. 3.

In an embodiment, both the first and second signal qualities can be RSRPs.

In an embodiment, the UE in the process (1000) can support simultaneous 4G LTE and 5G NR transmissions such as ENDC.

In an embodiment, the process (1000) can enable an LTE SA mode before an addition of an NR SCG.

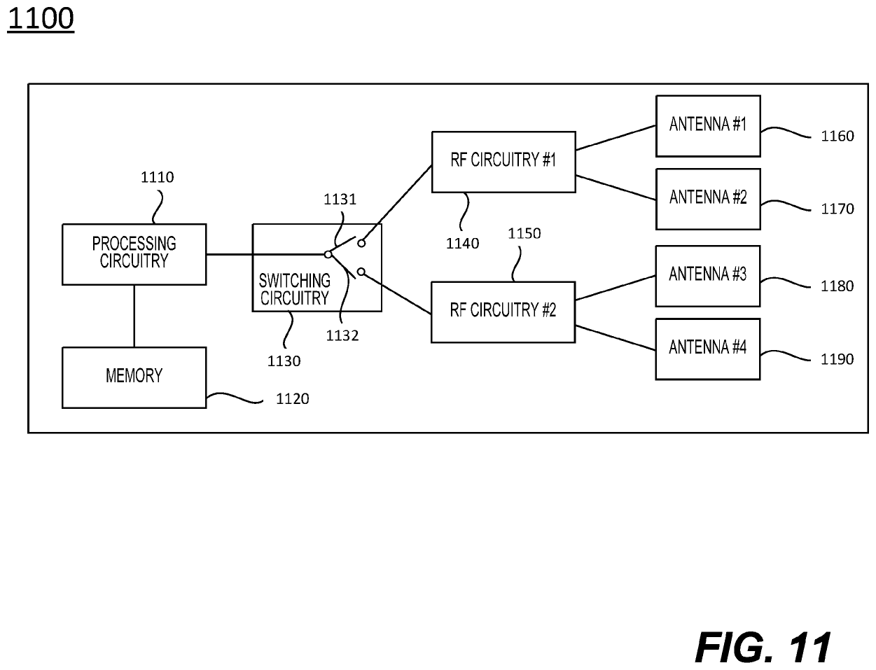

FIG. 11 shows a UE (1100) according to an embodiment of the disclosure. The UE (1100) can be configured to perform various functions in accordance with one or more embodiments or examples described herein. Thus, the UE (1100) can implement the techniques, processes, functions, components, systems described herein.

For example, the UE (1100) can be used to implement functions of the UE (500), the UE (600), the UE (700), and/or the UE (800) in various embodiments and examples described herein. The UE (1100) can include a general purpose processor or specially designed circuits to implement various functions, components, or processes described herein in various embodiments. The UE (1100) can include processing circuitry (1110), a memory (1120), switching circuitry (1130), two RF circuitry #1 (1140) and #2 (1150), and four antennas #1 (1160)-#4 (1190).

According to aspects of the disclosure, the UE in the process (900) or the process (1000) can be the UE (1100) in FIG. 11. Accordingly, the baseband processor in the process (900) or the process (1000) can be included in the processing circuitry (1110) of the UE (1100).

The first and second switches in the process (900) or the process (1000) can be the switches (1131) and (1132) of the switching circuitry (1130) of the UE (1100), respectively. The first and second RF transceivers in the process (900) or the process (1000) can be included in the RF circuitry #1 (1140) and #2 (1150) of the UE (1100), respectively. The first antenna in the process (900) or the process (1000) can be one of the antenna #1 (1160) and the antenna #2 (1170) of the UE (1100), and the second antenna in the process (900) or the process (1000) can be one of the antenna #3 (1180) and the antenna #4 (1190) of the UE (1100).

In various examples, the processing circuitry (1110) can include one or more baseband processors and a switch controller that controls the switching circuitry (1130). The one or more baseband processors can be same as or similar to one or more of the baseband processors of the UEs in FIGS. 5-8, such as the baseband #1 (501) of the UE (500), the baseband #2 (502) of the UE (500), the baseband #1 (601) of the UE (600), the baseband #2 (602) of the UE (600), the baseband (701) of the UE (700), and/or the baseband (801) of the UE (800).

In various examples, the processing circuitry (1110) can include circuitry configured to perform the functions and processes described herein in combination with software or without software. In various examples, the processing circuitry (1110) can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry (1110) can be a central processing unit (CPU) configured to execute program instructions to perform various functions and processes described herein. Accordingly, the memory (1120) can be configured to store program instructions. The processing circuitry (1110), when executing the program instructions, can perform the functions and processes. The memory (1120) can further store other programs or data, such as operating systems, application programs, and the like. The memory (1120) can include a read only memory (ROM), a random access memory (RAM), a flash memory, a solid state memory, a hard disk drive, an optical disk drive, and the like.

Each of the RF circuitry #1 (1140) and #2 (1150) can receive a processed data signal from the processing circuitry (1110) and convert the data signal to a wireless signal that is then transmitted via one of the four antennas #1 (1160)-#4 (1190). Each of the RF circuitry #1 (1140) and #2 (1150) can include a digital to analog convertor (DAC), an analog to digital converter (ADC), a frequency up convertor, a frequency down converter, filters and amplifiers for reception and transmission operations. Each of the RF circuitry #1 (1140) and #2 (1150) can include switching circuitry for selecting one of two antennas associated with the respective RF circuitry. For example, the RF circuitry #1 (1140) can include a DPDT switch circuit to select one of the two antennas #1 (1160) and #2 (1170).

The UE (1100) can include one or more additional devices and/or components, such as camera device(s), video and audio system(s), sensor(s), display screen(s), battery system(s), input and output device(s), additional memory device(s), additional processing circuitry, additional RF circuitry, additional switching circuitry, additional antenna(s), and the like. Accordingly, the UE (1100) may be capable of performing other additional functions, such as executing application programs, and processing alternative communication protocols.

In some embodiments, a subset of the one or more additional devices and/or components that are not shown in FIG. 11 can be coupled between the devices shown in FIG. 11. For example, a power amplifier device (not shown in FIG. 11) can be coupled between the RF circuitry #1 (1140) and the antenna #1 (1160), so that the RF circuitry #1 (1140) can transmit an RF signal to the power amplifier device which can amplify the RF signal that is then transmitted via the antenna #1 (1160).

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

Aspects of the disclosure provide a method of a UE for wireless communication. In the method, a first switch of the UE is switched on to couple a first RF transceiver of the UE to a baseband processor of the UE through the first switch. The first RF transceiver is associated with a first antenna of the UE. It is determined whether a first signal quality of a first reference signal received by the first antenna is greater than a first threshold. When the first signal quality of the first reference signal is equal to or less than the first threshold, a second switch of the UE is switched on to couple a second RF transceiver of the UE to the baseband processor of the UE through the second switch. The second RF transceiver is associated with a second antenna of the UE. A second signal quality of a second reference signal received by the second antenna is determined. One of the first antenna and the second antenna is selected as a transmit antenna based on a comparison between the first signal quality and the second signal quality.

In an embodiment, when the first signal quality of the first reference signal is greater than the first threshold, the first antenna is selected as the transmit antenna.

In an embodiment, it is determined whether a difference between the second signal quality and the first signal quality is greater than a second threshold. When the difference is greater than the second threshold, the second antenna is selected as the transmit antenna. When the difference is equal to or less than the second threshold, the first antenna is selected as the transmit antenna.

In an embodiment, it is determined whether a flag indicating the first signal quality is to be compared with the second signal quality is enabled. When the flag is disabled, the first antenna is selected as the transmit antenna.

In an embodiment, both the first signal quality and the second signal quality are RSRPs.

In an embodiment, the UE supports simultaneous the fourth generation 4G LTE and 5G NR transmissions.

In an embodiment, an LTE SA mode is enabled before an addition of an NR SCG.

Aspects of the disclosure further provide a UE for wireless communication. A switch controller of the UE switches on a first switch of the UE to couple a first RF transceiver of the UE to a baseband processor of the UE through the first switch. The first RF transceiver is associated with a first antenna of the UE. The baseband processor of the UE determines whether a first signal quality of a first reference signal received by the first antenna is greater than a first threshold. When the first signal quality of the first reference signal is equal to or less than the first threshold, the controller of the UE switches on a second switch of the UE to couple a second RF transceiver of the UE to the baseband processor of the UE through the second switch. The second RF transceiver is associated with a second antenna of the UE. The baseband processor of the UE determines a second signal quality of a second reference signal received by the second antenna. The baseband processor of the UE selects one of the first antenna and the second antenna as a transmit antenna based on a comparison between the first signal quality and the second signal quality.

In an embodiment, when the first signal quality of the first reference signal is greater than the first threshold, the baseband processor selects the first antenna as the transmit antenna.

In an embodiment, the baseband processor determines whether a difference between the second signal quality and the first signal quality is greater than a second threshold. When the difference is greater than the second threshold, the baseband processor selects the second antenna as the transmit antenna. When the difference is equal to or less than the second threshold, the baseband processor selects the first antenna as the transmit antenna.

In an embodiment, the baseband processor determines whether a flag indicating the first signal quality is to be compared with the second signal quality is enabled. When the flag is disabled, the baseband processor selects the first antenna as the transmit antenna.

In an embodiment, both the first signal quality and the second signal quality are RSRPs.

In an embodiment, the UE supports simultaneous 4G LTE and 5G NR transmissions.

In an embodiment, the baseband processor enables an LTE SA mode before an addition of an NR SCG.

Aspects of the disclosure further provide a non-transitory computer-readable medium storing instructions that, when executed by a computer, cause the computer to perform a method, the method comprising: switching on a first switch of a UE to couple a first RF transceiver of the UE to a baseband processor of the UE through the first switch, the first RF transceiver being associated with a first antenna of the UE, determining whether a first signal quality of a first reference signal received by the first antenna is greater than a first threshold, in response to the first signal quality of the first reference signal being equal to or less than the first threshold, switching on a second switch of the UE to couple a second RF transceiver of the UE to the baseband processor of the UE through the second switch, the second RF transceiver being associated with a second antenna of the UE, determining a second signal quality of a second reference signal received by the second antenna, and selecting one of the first antenna and the second antenna as a transmit antenna based on a comparison between the first signal quality and the second signal quality.

In an embodiment, when the first signal quality of the first reference signal is greater than the first threshold, the first antenna is selected as the transmit antenna.

In an embodiment, it is determined whether a difference between the second signal quality and the first signal quality is greater than a second threshold. When the difference is greater than the second threshold, the second antenna is selected as the transmit antenna. When the difference is equal to or less than the second threshold, the first antenna is selected as the transmit antenna.

In an embodiment, it is determined whether a flag indicating the first signal quality is to be compared with the second signal quality is enabled. When the flag is disabled, the first antenna is selected as the transmit antenna.

In an embodiment, both the first signal quality and the second signal quality are RSRPs In an embodiment, the UE supports simultaneous 4G LTE and 5G NR transmissions.

In an embodiment, an LTE SA mode is enabled before an addition of an NR SCG.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of a user equipment (UE) for wireless communication, the UE including a first path including a first radio frequency (RF) transceiver and a first antenna connected to the first RF transceiver;
a second path including a second RF transceiver and a second antenna connected to the second RF transceiver; and
a processor coupled to the first and second RF transceivers, the method comprising:
determining, by the processor, a first signal quality of a first signal received via the first antenna and the first RF transceiver;
determining, by the processor, a second signal quality of a second signal received via the second antenna and the second RF transceiver; and
selecting, based on a comparison between the first signal quality and the second signal quality, at least one of the first transceiver and the second transceiver for wirelessly communicating RF signals.

2. The method of claim 1, further comprising:
changing the selected at least one of the first transceiver and the second transceiver for wireless long term evolution (LTE) communications, based on a comparison of an updated first signal quality and an updated second signal quality.

3. The method of claim 1, further comprising:
changing the selected at least one of the first transceiver and the second transceiver for fifth generation (5G) new radio (NR) communications, based on a comparison of an updated first signal quality and updated second signal quality.

4. The method of claim 1, wherein the selecting comprises:
selecting the first and the second transceivers for simultaneous 5G NR and LTE communications.

5. The method of claim 4, wherein the first transceiver is selected to be active for LTE communications and the second transceiver is selected to be active for 5G NR communications, based on the determined first signal quality and the determined second signal quality.

6. The method of claim 5, further comprising:
changing the first transceiver to be active for 5G NR communications and the second transceiver to be active for LTE communications, based on a comparison of an updated first signal quality and an updated second signal quality.

7. The method of claim 1, further comprising:
in response to the first signal quality of the first signal being greater than a first threshold, selecting, by the processor, the first antenna as a transmit antenna.

8. The method of claim 7, wherein the selecting comprises:
determining, by the processor, whether a difference between the second signal quality and the first signal quality is greater than a second threshold.

9. The method of claim 8, further comprising:
in response to the difference being greater than the second threshold, selecting, by the processor, the second antenna as the transmit antenna.

10. The method of claim 8, further comprising:
in response to the difference being equal to or less than the second threshold, selecting, by the processor, the first antenna as the transmit antenna.

11. A user equipment (UE) for wireless communication, the UE comprising:
a housing;
a first transceiver carried in the housing;
a first antenna carried in the housing and connected to the first transceiver to receive wireless signals;
a second transceiver carried in the housing;
a second antenna carried in the housing, the second antenna spaced from the first antenna and connected to the second transceiver to receive the wireless signals; and
a processor carried in the housing, the controller configured to
determine a first signal quality of a first signal received via the first antenna and first transceiver,
determine a second signal quality of a second signal received via the second antenna and the second transceiver,
select at least one of the first transceiver and the second transceiver to receive the wireless signals based on a comparison of the determined first and second signal qualities, and
change the selected transceiver based on a comparison of updated determined first and second signal qualities.

12. The UE of claim 11, wherein the first antenna is positioned near a first edge of the UE housing.

13. The UE of claim 12, wherein the second antenna is positioned near a second edge of the UE housing, the second edge being opposite to the first edge.

14. The UE of claim 12, further including a third antenna connected to the first transceiver, and positioned near the first edge of the UE housing.

15. The UE of claim 12, further including a forth antenna connected to the second transceiver, and positioned near the first edge of the UE housing.

16. The UE of claim 11, wherein the processor is further configured to:
in response to the first signal quality of the first signal being greater than a first threshold, select the first antenna as a transmit antenna.

17. The UE of claim 16, wherein the processor is further configured to:
determine whether a difference between the second signal quality and the first signal quality is greater than a second threshold.

18. The UE of claim 17, wherein the processor is further configured to:
in response to the difference being greater than the second threshold, select the second antenna as the transmit antenna.

19. The UE of claim 17, wherein the processor is further configured:
in response to the difference being equal to or less than the second threshold, select the first antenna as the transmit antenna.

20. A non-transitory computer-readable storage medium including computer executable instructions, wherein the instructions, when executed by a computer, cause the computer to perform a method, the method comprising:
switching on a first switch of a user equipment (UE) to couple a first radio frequency (RF) transceiver of the UE to a baseband processor of the UE through the first switch, the first RF transceiver being associated with a first antenna of the UE;
determining whether a first signal quality of a first signal received via the first antenna is greater than a first threshold;
in response to the first signal quality of the first signal being equal to or less than the first threshold,
switching on a second switch of the UE to couple a second RF transceiver of the UE to the baseband processor of the UE through the second switch, the second RF transceiver being associated with a second antenna of the UE;
determining a second signal quality of a second signal received via the second antenna; and
selecting one of the first antenna and the second antenna as a transmit antenna based on a comparison between the first signal quality and the second signal quality.
